(19) United States
(12) Patent Application Publication
(10) Pub. No.: US 2024/0193102 A1
(43) Pub. Date: Jun. 13, 2024

(54) PROCEDURE AND SYSTEM TO IMPROVE THE USER EXPERIENCE USING CAPABILITIES OF A DIFFERENT ELECTRONIC DEVICE

(71) Applicant: Universidade de Vigo, Vigo (ES)

(72) Inventors: Felipe Jose Gil Castineira, Vigo (ES); Francisco Javier Gonzalez Castono, Vigo (ES)

(21) Appl. No.: 18/077,640

(22) Filed: Dec. 8, 2022

(51) Int. Cl. G06F 13/12; G06F 3/14

(52) U.S. Cl. CPC G06F 13/122; G06F 3/1454

(57) ABSTRACT

Procedure and system to improve the user experience when running applications on electronic devices are disclosed. An example method and system allow the execution of multiple user applications available on at least one first electronic device (for example, a smartphone) using some of the (best) capabilities of at least one second electronic device of a second type (for example, a desktop PC). Any number of devices of the first type (first electronic devices) can interact (share inputs/outputs) with a single second electronic device. Furthermore, a single first electronic device can interact (share the inputs/outputs of different applications) with several second electronic devices.

### BACKGROUND OF THE INVENTION

Mobile phones, and especially smartphones (actually nowadays most mobile phones are considered smartphones), are the main gateway end users employ to access information. (In 2017, almost 2.4 billion people used a mobile phone.) End users install applications (interchangeably referred to herein as an “app”) on their smartphones to read their email, check their bank accounts, talk with friends or colleagues, interact through social networks, access news, edit images, play games, surf the Internet, etc. Mobile phones are also tools when workers are not static (in a manufacturing plant, during a field trip, during a maintenance operation, a visit to a client, etc.), for example to receive instructions or capture information.

Typically, mobile phones (such as smartphones) have enough computing power and network capabilities to run any existing user applications. Compared to other electronic devices, such as desktop PCs, the main limitation of today's smartphones is their limited user interface due to their small screens. This makes smartphones suitable for content consumption or occasional content generation (short messages and short emails), but their touch screens are uncomfortable for editing long documents (making this task unfeasible in practice) or entering information while performing another task (since using a smartphone typically requires both hands).

However, there are many situations in which the user of a mobile terminal has sporadic access to devices with better capabilities for user interaction (for example, with superior input/output characteristics), such as touch panels, keypads, desktop computers, laptops, tablets, television sets, set-top boxes, other smartphones, or any other electronic or computing devices with larger screens or better interfaces. This can happen either at home or at work. In this second scenario, users may have devices with different input/output (I/O) capabilities to facilitate their tasks, either locally or from remote servers. In those remote servers their personal information or applications may not be available or may be configured incorrectly.

In order to take advantage of electronic devices with better user interfaces (better I/O capabilities) than smartphones, we could install the applications we want to use on smartphones, but this solution leads to various problems. For example, the need to allocate time and other resources to the installation of all the applications that all potential users may need; the possibility that the desired application will not be available for devices with better interfaces or their operating systems; having to enter our app passwords on multiple devices; having to configure the same application for each target device; the possibility that the owners of said devices (other persons, not us) will uninstall the applications (or erase our user credentials) at some point; the need to update the state (information, work documents, or the like) of the app on different devices to match the state of the app on the smartphone, etc.

Some previous solutions have tried to improve the user experience of a first electronic device with restricted input and output capabilities by using a second electronic device. For example, by making a first electronic device serve multimedia content to an external screen (this is the case, for example, of U.S. Pat. No. 7,587,520 B1 “Image display system with visual server”). However, these prior inventions do not support the outputs of any application nor can they support user interactions with the applications.

Other previous solutions have tried to improve the user experience by allowing access to the application of a first device through the (better) input and output mechanisms of a second device (this is the case, for example, of the US patent 2016/057266 A1 Zhao Tony et al 25-2-16). This prior invention proposes the use of a second device with minimized capabilities (except with respect to the interface). Therefore, only a single application can be accessed from the second device at any given time. However, in both home and business environments, users need to simultaneously access multiple concurrent applications (often through a graphical windowed environment) that can run on the first device, the second device, or both. The previous solutions do not propose any mechanism that allows simultaneous access from the second device to different applications that are executed concurrently in the first, or that allows the simultaneous execution of applications both in the first device and in the second device.

Therefore, in the arts of mobile phones, and in particular smart phones, there is a need in the arts for improved methods, apparatus, and systems for concurrently using a mobile phone and other electronic devices.

### SUMMARY OF THE INVENTION

The present invention uses a novel method and system that will improve the user experience when running applications on electronic devices by allowing multiple concurrent user applications from at least a first electronic device of a first type (a mobile electronic device, for example a smartphone) benefit from some of the (better) capabilities of a second electronic device of a second type (for example a desktop PC).

The present method and system relate to one or more first electronic devices of a first type having a first set of device capabilities (input/output, processing, user interfaces, communication and operating system capabilities, or any other device capabilities) that interact with the electronic device(s) of a second type having a second set of capabilities (input/output, processing, user interfaces, communication and operating system capabilities, or any other electronic device capabilities).

In one embodiment, the first electronic device will be a smartphone and the second electronic device will be a desktop PC. In other embodiments, the first electronic device could be a laptop, mobile phone, or any other type of mobile electronic device, and the second electronic device could be a PC, touch panel, embedded system, laptop, mobile phone or any other type of electronic or computer device.

The first and second electronic devices can detect each other (with no explicit addressing configuration involved) as long as they are on the same communications network or on different communications networks interconnected by a tunneling protocol (the communications network may be a local area network, a mobile communications network, a wide area network or, in general, any type of communications network). The user can activate reciprocal device discovery by selecting icons on the user interface of any of the devices. Multiple applications may be executed concurrently on the first electronic device and the first electronic device may simultaneously deliver the outputs (e.g., graphical output) of said executed applications to the second electronic device. The second electronic device will also be able to execute applications concurrently with other local applications and the applications executed in the first device), The second electronic device will be able to reproduce the aforementioned outputs with a suitable screen or player (for example, a player that is available for any operating system). The second electronic device may capture user input (via an input/output sharing service) and provide such user input to applications on the first electronic device.

Any number of devices of the first type (first electronic devices) with different operating systems can provide outputs corresponding to multiple concurrent applications to a single electronic device. In one embodiment, the second electronic device may have a multitask operating system and the second electronic device may display windows corresponding to locally running applications and to outputs from applications served by one or more first electronic devices (for example, a window for each application). In another embodiment, a first electronic device may simultaneously deliver output from multiple concurrent applications to several second electronic devices. In another embodiment, multiple first electronic devices may simultaneously deliver output from multiple concurrent applications to one or more second electronic devices.

The present invention involves several advantages over previous solutions. For example, the present invention provides a method of discovering the first or second electronic devices; the present invention is suitable for multi-application scenarios in which a first electronic device can simultaneously serve multiple user applications, while other applications can be executed locally and simultaneously in the operating system of the second electronic device; the present invention allows the user to select in the second electronic device the applications of the first device with which he wants to interact, etc.

In a first aspect, the present invention proposes a method for improving the user experience (when multiple applications are executed concurrently) of a user of at least one first electronic device with a first set of device capabilities, where the first electronic device is a mobile electronic device, the procedure comprising:
a) obtaining identity information from the first electronic device by at least a second electronic device with a second set of device capabilities (usually different from the first set), wherein the identity information is received through the same communications network of the first electronic device or through another communications network that is interconnected with the network communications of the first electronic device, or vice versa (that is, the first electronic device obtaining identity information from the second electronic device);
b) establishment of a connection between the first electronic device and the second electronic device (through one or more communication networks);
c) simultaneously sending from the first electronic device to the second electronic device, once encoded as appropriate messages for efficient transmission, the outputs of multiple concurrent (software) applications, previously selected by the user, that are running on the first electronic device, and the second electronic device providing said outputs to the user (through a screen, a player, a loudspeaker or, in general, through the appropriate user interface);
d) receiving a user's input through a user input/output sharing service of the second electronic device, and the second electronic device sending the user's input to the first electronic device, to be passed to the applications (some applications among those previously selected by the user that are executed in the first electronic device).

The user can obtain the identity information (also called identification information) “manually”. For example, the user may instruct the second electronic device to display a visual code containing the identity of the second electronic device and the user may instruct the first electronic device to read (scan) the information contained in the visual code, or the user may command the first electronic device to display a visual code containing the identity of the first electronic device and the user may command the second electronic device to read (scan) the information contained in the visual code.

Alternatively, an automatic discovery mechanism can obtain the identification information. For example, the second electronic device may detect the presence of the first electronic device by receiving publication or announcement signals (e.g., wireless signals) sent by the first electronic device (including the identity information of the first electronic device) or the first electronic device can detect the presence of the second electronic device by receiving the publication or announcement signals (e.g., wireless signals) sent by the second electronic device (including the identity information of the second electronic device).

In one embodiment, after step b) and before step c) above, the method includes the following steps to select multiple applications:
The first electronic device sending to the second electronic device a list of applications available on the first electronic device, through the established connection;
The second electronic device presenting to the user the list of available applications;
The user selecting on the second electronic device multiple applications;
The second electronic device sending a message to the first electronic device that reports the selected applications; and
The first electronic device launching the applications if they have not been launched yet.

Alternatively, the first electronic device may display to the user a list of applications that are available on the first electronic device, the user may select one or more applications, and the first electronic device may launch the applications. And then the first electronic device may send a message to the second electronic device informing it of the selected applications.

In one embodiment, in step c), the outputs of the multiple applications running concurrently on the first electronic device are simultaneously captured and sent to the second electronic device, either directly (by the applications themselves) or through a separate process of the applications in the first electronic device. In one embodiment, in step d), applications running concurrently on the first electronic device may accept inputs directly from the second electronic device, or a process that is independent from the applications on the first electronic device may receive inputs from the second electronic device and pass them to the applications.

In one embodiment, after obtaining the identification information of the other electronic device (step a), the method includes the following steps: that the first electronic device asks the user, through a user interface of the first electronic device, if he/she agrees to associate one or multiple applications with the second electronic device; or that the second electronic device asks the user, through a user interface of the second electronic device, if he/she agrees to establish an association with one or multiple applications of the first electronic device; where, if the user does not accept, the procedure ends.

In one embodiment, the connection is secured (e.g., by authentication and connection encryption) using security credentials (such as certificates). In this case, step b) may include: the first and/or second electronic devices checking whether they have previously completed a connection and, if so, each electronic device obtaining the other electronic device's certificate from a database; otherwise, the first and second electronic devices exchanging their certificates. In this case, any mechanism can be used to exchange the certificates. For example, any of the two electronic devices (first or second) displays a QR code that includes its security certificate and the other electronic device scans said QR code and extracts the certificate.

In one embodiment, the first electronic device may be a mobile phone (for example, a smartphone) and the second electronic device may be a laptop, wearable computer, touchpad, embedded system, tablet, desktop, or other mobile phone.

Typically, prior to step c), the second electronic device will have been authorized (for example, through the exchange of appropriate messages between the first and second electronic devices, or through any other known mechanism) to access multiple applications on the first electronic device.

The first and second electronic devices may be on the same network (wireless local area network) or on different networks (wireless local area networks) interconnected by one or more tunneling protocols.

In one embodiment, in step c), the second electronic device simultaneously displays the output of one or more concurrent applications in different windows of the windows screen of its operating system. If the second electronic device also runs local applications, the second electronic device may display, in different windows of its operating system windows screen the inputs/outputs of its local applications and the inputs/outputs corresponding to the applications of the first electronic device. There may be more than one first electronic device and more than one second electronic device. For example, in one embodiment, in addition to the first electronic device, there may be at least another mobile electronic device that interacts with the second electronic device that performs the previously disclosed method steps (by simultaneously sending to the second electronic device the outputs of multiple concurrent applications and receive from the second electronic device the user's inputs for said applications that the other mobile device executes concurrently). Or, for example, in another embodiment, the first electronic device also performs the steps of the procedure with at least another electronic device different from the second electronic device, to interconnect the inputs and outputs of multiple applications running concurrently on said first electronic device with the aforementioned different electronic device (i.e., in addition to the second electronic device, there is at least another electronic device that simultaneously receives from the first electronic device the outputs of multiple concurrent applications of said first electronic device and sends to the first electronic device inputs for said applications following the same steps of the procedure).

Communications between the first and second electronic devices in steps c) and d) are normally performed using the connection established in step b), but a different connection may be used.

In a second aspect, the present invention proposes a system for improving the experience of a user of at least one first electronic device with a first set of device capabilities, where the first electronic device is a mobile electronic device (for example, a mobile phone), the system comprising:
at least one second electronic device having a second set of device capabilities, the second electronic device comprising:
   obtaining the identity (identification information) of the first electronic device located in the same communications network of the second electronic device or in a different communications network interconnected with the communications network of the second electronic device (for example, using a discovery mechanism);
   establishing a connection with the first electronic device once the second electronic device has obtained the identification of the first electronic device, or vice versa (the first electronic device has obtained the identification of the second electronic device);
   a receiver for simultaneously receiving from the first electronic device (e.g. through the established connection) the outputs of multiple applications, previously selected by the user, running concurrently on the first electronic device;
   a first user interface (a screen, a player, a speaker or any other suitable user interface) for providing said received outputs to the user;
   a second user interface (a keyboard, mouse, touch screen, or any other suitable user interface) for receiving user inputs for applications running concurrently on the first and/or second electronic device. The second interface can be the same as the first user interface or a different interface;
   a transmitter for transmitting to the first electronic device the inputs received for the applications (and for transmitting the signals announcing the presence of the second electronic device if that discovery mechanism is used);
a first electronic device comprising:
   establishing a connection with the second electronic device;
   a transmitter to simultaneously transmit to the second electronic device the outputs of multiple applications, which are previously selected by the user, and are executed concurrently in the first electronic device (and to transmit the signals that announce of the presence of the first electronic device if that discovery mechanism is used);
   a receiver for receiving from the second electronic device (e.g. via the established connection) the inputs for the applications.

Alternatively, the means for obtaining the identity (identification information) of another electronic device may be located on the first electronic device instead of the second electronic device. That is, the first electronic device may include means to obtain the identity (identification information) of the second electronic device located in the same communications network of the first electronic device or in a different communications network interconnected with the communications network of the first electronic device.

Another aspect of the present invention discloses a computer program, which comprises a computer program code adapted to carry out the steps of the described procedures, when said program is executed in a processing entity (for example, an entity of a wireless network), said processing entity being, for example, a computer, a digital signal processor, a field programmable gate array (FPGA), an application specific integrated circuit (ASIC), a microprocessor, a microcontroller, or any other form of programmable hardware. Also considered is a non-transient digital data storage medium for storing a computer program comprising program code instructions that when loaded into a computer system control cause the computer system to perform all steps of the disclosed methods.

### BRIEF DESCRIPTION OF THE DRAWINGS

To complete the description and in order to provide a better understanding of the invention, a set of drawings is provided. Said drawings form an integral part of the description and illustrate a preferred embodiment of the invention, which should not be interpreted as restricting the scope of the invention, but rather as an example of how the invention can be carried out. The components in the drawings are not necessarily to scale relative to each other. Like reference numerals designate corresponding parts throughout the several views.

FIG. 1 represents a diagram illustrating some of the blocks of the discovery procedure and the connection establishment procedure implemented in accordance with an embodiment of the present invention.

FIG. 2 represents a block diagram illustrating the interaction between the electronic devices implemented in accordance with an embodiment of the present invention.

### DETAILED DESCRIPTION

The present invention proposes a method and a system to allow the interaction between one or more first electronic devices with certain system capabilities and one or more second electronic devices with (better) system capabilities (a second electronic device will normally have more interaction capabilities that will be tailored to user needs). Specifically, the proposed method and system allow a user to run multiple concurrent applications on his/her first electronic device (for example, a smart mobile phone also called a smartphone) and use a second electronic device to take any output (image, text, video, etc.) of the applications running on the first and/or second electronic devices or simultaneously interacting with those applications, as well as to enter inputs for the latter (text, touch events, sensor data, etc.). In this way, for example, the user can interact with multiple concurrent applications running on his/her smartphone from a desktop, touch panel, embedded system, laptop, tablet, other smartphone, etc.

The first electronic device is a mobile electronic device, also known as a mobile device (a mobile phone, a smartphone, a laptop, a tablet, etc. or, in general, any mobile terminal with wireless communications capabilities) and the second electronic device can be any type of electronic or computing device.

The various embodiments will become better understood through review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations, however, for the sake of brevity, each and every contemplated variation is not individually described in the following detailed description.

Throughout the following detailed description, a variety of example embodiments are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components. “Secured to” means directly connected without intervening components.

“Communicatively coupled” means that an electronic device exchanges information with another electronic device, either wirelessly or with a wire based connector, whether directly or indirectly through a communication network. “Controllably coupled” means that an electronic device controls operation of another electronic device.

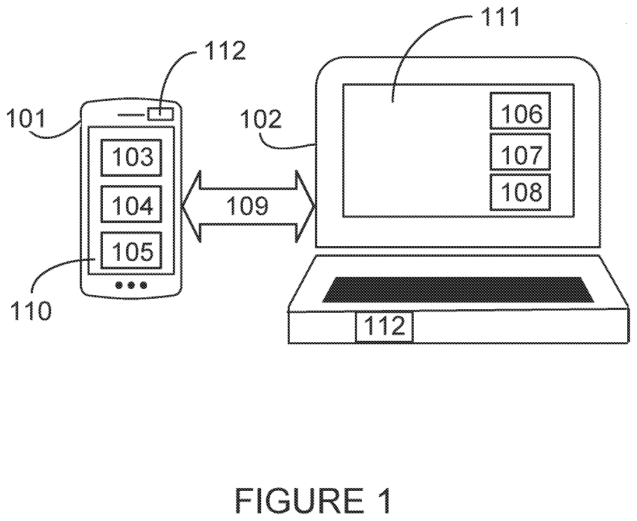

FIG. 1 shows a block diagram illustrating some of the functions implemented in accordance with an embodiment of the present invention. In FIG. 1, the first electronic device (101) is a mobile phone (more specifically a smartphone) and the second electronic device (102) is a laptop or a desktop computer (this is just a non-limiting example and any other electronic device could be used).

In order to carry out the present invention, the first and second electronic devices may include some functions or services (each of said functions or services being implemented by a functional module or element). Said functions or services can be announcement services (103, 106) to announce the presence of the devices, discovery services (104, 107) so that an electronic device discovers the presence of another electronic device, and connection services (105, 108).

First, any of the electronic devices (101, 102) involved must determine the presence of the other devices and establish a connection (109).

If the electronic devices (101, 102) have not previously been connected, they must find each other and establish a connection (109). To do this, in one embodiment, when the devices (101, 102) are close together, the second electronic device (102) detects the first electronic device (101) (or, alternatively, the first electronic device detects the second electronic device), using an (automatic) discovery mechanism and both devices establish a (secure) connection (109).

Alternatively, the pairing between the electronic devices (101, 102) can be manual or, in other words, the user can “drive” the contact between the electronic devices (101, 102). That is, the user provides one of the electronic devices (first or second) with the identity of the other device and any information that is necessary to establish a (secure) connection and one of the electronic devices contacts the other electronic device and establishes with it a (secure) connection (109). In a specific embodiment, for this purpose, the user can request one of the electronic devices (first or second) to display a visual code (for example, a QR code) with the identity of that electronic device, as well as any information that is necessary to establish a (secure) connection (109). The user can use the (second or first) companion electronic device to read (e.g. scan) the visual code, so that the companion electronic device can use the information obtained from the visual code to establish a (secure) connection (109). In another embodiment, the user may directly provide such information to the electronic device (e.g., through a user interface) or use any other mechanism.

In the event that at least one connection between the electronic devices (101, 102) has been completed in the past, an (automatic) discovery mechanism is normally used so that one of the devices detects the presence of the other (because it is possible that the positions of electronic devices (101, 102) have changed and they are no longer close enough). That is, when the electronic devices (101, 102) are in close proximity, the second electronic device (102) discovers the first electronic device (101) (or alternatively, the first electronic device discovers the second electronic device) through a discovery mechanism and both devices (101, 102) establish a (secure) connection (109) (since the electronic devices have already completed at least one connection in the past, any of them may have stored the credentials and other necessary information of its companion during the connection, so it is not necessary for them to exchange this information again).

Next this procedure will be explained in more detail.

In case the manual procedure is used (for example, if the first electronic device (101) and the second electronic device (102) have not previously completed a connection, although the manual procedure can be used in any case): the user can request the second electronic device (102) to display a visual code on a display (111) that provides the identity of the second electronic device and any information to establish a (secure) connection (such as interface and connection technology, network and transport level address, a public certificate, etc.). The user can then request the first electronic device (101) to read the information provided by the visual code and use that information to establish a (secure) connection (109) with the second electronic device (102). In an alternative embodiment this can be done the other way around, i.e. the first electronic device (101) will provide the user with its identity and any information to establish a (secure) connection (for example, presenting that information as a visual code on the screen). Next, the user must request the second electronic device (102) to read said information and establish a (secure) connection (109) between both devices.

In case a discovery mechanism is used (as indicated above, the discovery mechanism can be used whether or not a connection between the electronic devices has previously been completed): the first electronic device (101) will periodically report its presence (103) through some or all of the existing network connections and/or through the notification services of known technologies (such as Wi-Fi Direct, Bluetooth, or any other). The second electronic device (102) will continuously search for compatible devices in the environment using the discovery service (107) or those of technologies such as Wi-Fi Direct, Bluetooth or any other known technology. Pre-existing connection information (if any) could also be used for discovery purposes (in case the devices involved had already been connected to the same Wi-Fi local area network or any other technology or had already been connected via a USB point-to-point connection, Bluetooth or any other technology).

In one embodiment, the (automatic) discovery mechanism can work as follows: for example, the first electronic device (101) can emit a signal that includes its identity (ID) and other device information and the second electronic device (102) can receive said signal, and check in a database if it is compatible with the first electronic device (101) or if it has previously authorized a connection with the first electronic device (101) (that is, the second electronic device checks if it can interact with the first electronic device). Alternatively, the second electronic device (102) may issue a device request signal, and the first electronic device (101) may provide a response including its identity and any other information, and the second electronic device (102) may receive then that answer, and check in a database if it is compatible with the first electronic device (101) or if it has previously authorized a connection with the first electronic device (101) (usually, two electronic devices that have completed a connection in the past are compatible, so there is no need to check it against the database). Each time the second electronic device (102) discovers a compatible/authorized first electronic device (101), it may ask the user if he/she wishes to establish an association with concurrent applications of the first electronic device (101) (alternatively, the second electronic device may be configured to automatically establish an application level association). Upon discovery, the second electronic device (102) will use the connection service (108) to establish a connection (109) with the first electronic device (101) (using any known communications protocol) through a communications network (for example, a local area communications network, a mobile communications network, or any other communications network). Alternatively, the user can create a connection (109) between the two devices by any means, such as connecting both devices to the same Wi-Fi local area network or any other technology and/or establishing a USB point-to-point connection, a Bluetooth connection or a connection with any other technology. The discovery service running on the second device (107) can then use the resulting connection (109) to interact with the announcement service running on the first device (103) to create an application level association.

Alternatively, discovery can take place the other way around, i.e. if the second electronic device (102) periodically announces its presence (106) or responds to a device request signal issued by the first electronic device (101); the first electronic device (101) will discover the second device and ask the user if he/she wants to establish an application level association with the second electronic device, and use the connection service (105) to establish a connection (109) with the second electronic device.

Once the discovery has been made, a connection (109) (usually a secure connection) must be established between the electronic devices (101, 102), by any known method. According to one embodiment, the connection (109) must be authenticated and encrypted using suitable credentials (general secure communications credentials or specific credentials for the requested service, i.e., input/output exchange credentials). In an embodiment example, certificates are used to authenticate/encrypt communications. Credentials are normally only exchanged during the first connection between both electronic devices, because, during this first connection, each device stores the identification and credentials (certificates) of the other device to facilitate future secure connections without user intervention and/or or without requesting the credentials again. In other words, if the electronic devices (101, 102) have completed at least one connection in the past, each device will have stored during that connection the credentials and any other necessary information about the other to establish a secure connection (109), so there is no need to exchange this information again.

Next this procedure will be explained in more detail with a specific example (this is only a non-limiting example and any other procedure could be used to establish a secure communication). In this example, in order to ensure communication, one of the electronic devices (e.g., the second electronic device 102 establishing the communication) checks whether a connection with the first electronic device (101) has previously been completed. It does this through its own functional element (service) that is responsible for sharing its input/output with another electronic device (implemented as part of the present invention). Such a functional element will be referred to herein as the input/output sharing service. If the second electronic device (102) has previously completed a connection with the first electronic device (101), or they have exchanged the credentials by other means, such as the manual procedure, the input/output sharing service will establish communication using the credentials (certificates) of the first device (101) already stored in the second electronic device (102). If not, the second electronic device (102) provides its public certificate to the user (for example, by presenting the certificate as a QR code on the screen of the second electronic device). The user must install on the first electronic device (101) the public certificate of the input/output sharing service provided by the second electronic device (102). This can be performed, for example, by scanning the QR code of the second electronic device (102), using a feature of the input/output sharing service that will run on the first electronic device (101), which will scan the QR code and extract the public key from the QR code. User participation ensures that he/she owns (or has access to) both devices (101, 102) and avoids the need for a public key infrastructure to prevent a man-in-the-middle attack.

Once an electronic device has read the credentials (public key) of the other device for the requested service (input/output sharing service), both electronic devices (101, 102) (or more specifically the corresponding input/output sharing services of the devices) establish a connection (109) at the application level using any conventional method (such as TCP or UDP sockets). Typically, both electronic devices (101, 102) will exchange temporary public keys for the session and store their permanent public keys in tables that associate those keys to a unique ID for each device. In this way, any future connection can be established without repeating the authentication procedure. That is, to establish future connections, the second electronic device (102) will complete the discovery procedure, read the unique and permanent identifier (such as a physical address) of the first electronic device (101) announced by the first electronic device, and with that identifier, the second electronic device (102) will extract the public key of the first electronic device (101) from a table where said public key will have been stored during the first established connection, and will send a connection request to the first electronic device (101). After the connection request, the first electronic device (101) will identify the second device (102) and extract from a table the public key associated with the second electronic device that will have been stored during the first established connection, and will complete the new connection, which from then on will be safe.

In the explanations of the two previous paragraphs it has been assumed that the second electronic device (102) is the device in charge of establishing the communication. The same explanations can be applied (by trivially substituting what needs to be changed) in case the first electronic device (101) is the device in charge of establishing the communication.

Once the secure connection (109) (also called secure communication) between both electronic devices is established, the electronic devices (101, 102) interact in order to share the input/output of the desired applications.

Communications between the electronic devices (101, 102) are implemented using a suitable receiver and a suitable transmitter (interchangeably referred to herein as a transceiver 112).

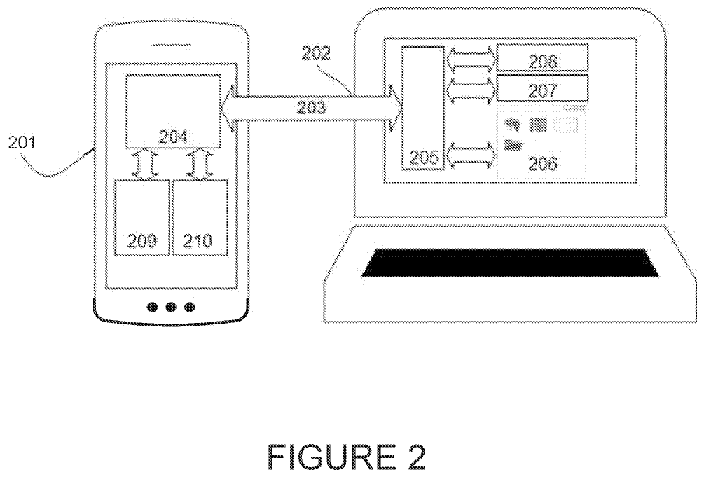

FIG. 2 illustrates said interaction between the first electronic device (201) and the second electronic device (202), once a secure connection (203) has been established between both devices. More specifically, it can be said that these interactions take place between the functional elements of each electronic device in charge of the sharing service; that is, between the input/output sharing service (204) running on the first electronic device (201) and the input/output sharing service (205) running on the second electronic device (202).

The input/output sharing service (204) on the first electronic device (201) may send a list of compatible applications available on the first electronic device (201) to the input/output sharing service (205) on the second electronic device (202). A management application on each device (201, 202) can be used to view or remove authorized devices. The second electronic device (202) can display (206) through a user interface (for example a windows screen) the management application that provides the list of applications available in the first electronic device (201). When the user selects applications through the second electronic device's interface (for example, by clicking on a list of application icons on the windows screen), the second electronic device (202) sends a message to the first electronic device (201) that identifies the selected applications, and the first electronic device (201) launches the identified applications if they are not already running (209).

Applications running concurrently on the first electronic device (201) may themselves capture their outputs (209). Alternatively, the input/output sharing service (204) (or other application-independent service) of the first electronic device (201) will capture such outputs and send them simultaneously to the second electronic device (202), once appropriately encoded for transmission. The input/output sharing service (205) of the second electronic device will create a virtual instance or “avatar” (207, 208) for each application (209, 210) running on the first electronic device (201), and a connection will be established with the process that will be capturing the outputs of said applications (that is, with the applications themselves (209, 210) or with the input/output sharing service (204) that is common to all of them). The connection may be multiplexed over the existing secure link (203) or a new secure connection may be established. Each application (209, 210) running on the first device (201) will present results to the user through its own avatar (207, 208). These avatars will share the user interface with the local applications of the second device (202).

Furthermore, the avatars (207, 208) can capture any user input or interaction on the second electronic device (202), create a message with that information, and send it to the corresponding application (209, 210) running on the first electronic device (201) (or to the input/output sharing service or to another service independent from the applications (204) of the first electronic device (201), which will provide said input to the corresponding application (209, 210) in the first electronic device (201)). It can then be said that the first electronic device (201) replicates the user's interactions that take place on the second electronic device (202) as if the user had performed them locally on the first electronic device (201).

For example, if the application is a banking application and the user wants to type a certain amount of money to be transferred to a certain account number, he/she can type the account number (the amount of money) on the second electronic device (202), the second electronic device (202) may send said information to the first electronic device (201), and the first electronic device (201) may pass said account number to the banking application on the first electronic device (201) exactly as if the user had typed said number into the first electronic device (201).

In another example, the user can launch the management application (206) on his/her desktop computer (second electronic device (202)), and see the list of compatible applications available on his smartphone (the first electronic device (201)). The user can select a chat application in the management application (206), which will send a message to the input/output sharing service (204) running on the smart phone (201) requesting it to launch a second concurrent chat application (210) if not concurrently running yet. When this second application is launched, an acknowledgment is sent to the input/output sharing service (205) running on the desktop computer (202), which generates a new instance of the avatar (207). The chat application (210) or input/output sharing service running on the smart phone (201) generates a stream of messages that encrypts the output of the chat application. The avatar on the second electronic device (207) regenerates the output of the chat application from said messages and presents it to the user. The avatar (207) captures any user-generated events (e.g. mouse or keyboard events) and encodes them as messages that are forwarded to the chat application running concurrently on the first electronic device (210). In this way, the user sees the chat application on his/her computer and interacts with the avatar (207) as he/she would if he/she accessed the chat application directly on the smartphone.

In an alternative embodiment, the user does not select the applications on the second electronic device (202), but rather selects them directly on the first electronic device (201). When the user selects and launches the applications (209, 210 or any other) on the first device (201), the applications themselves or the input/output sharing service (204) (or other application-independent service) of the first electronic device (201) may notify the user of the availability of the input/output sharing service (205) of the second electronic device (202) supporting a better interaction. If the user agrees to activate the functionality, as explained above for the other embodiment, the applications themselves (209, 210 or any other) or a process independent from the applications of the first electronic device (201) (such as the input/output sharing service (204)) capture the outputs of the applications and these outputs are replicated in the avatars (207, 208 or as many as appropriate) that are executed in the second electronic device (202). As before, the avatars (207, 208, or as many as appropriate) can capture any user input or interaction on the second electronic device (202), encode it as messages, and send them to the corresponding application (209, 210, or any other) running on the first device (201) or to the input/output sharing service (204) (or other application-independent service) of the first electronic device (201), which will provide said input to the corresponding application on the first electronic device (201).

In another alternative embodiment, the user does not select the applications on the second electronic device (202), but the user or an administrator previously establishes contextual rules (on the first device, the second device and/or on a remote server) (absolute location, relative location between devices, signal measurement, detection of the presence of devices, etc.) that establish that certain applications of the first device (201) are shown on the second device (202) in certain situations.

The first electronic device (201) can ask a remote server if the applications are authorized to use the functionality proposed in the present invention.

Besides, the present invention proposes a method and system for sharing capabilities (especially input and output capabilities) between electronic devices (also called computing devices), having different levels of system software and/or hardware capabilities. Said electronic devices are one or more first electronic devices (normally mobile electronic devices, for example a mobile phone or a smartphone, with different applications that the user can select and launch whenever he/she wants), which concurrently execute multiple applications, and one or more second electronic devices (for example, a laptop, a touchpad, an embedded system, a tablet, a desktop PC or even another smartphone . . . ) that usually have better input and output capabilities, or in other words, better user interfaces.

Even though the steps of the proposed invention have already been explained (according to embodiments of the invention), for a better understanding of the invention they will be summarized below (this is just an example and not all steps are essential for the invention):

The second electronic device may detect the presence of at least one first electronic device (or the first electronic device may detect the presence of the second electronic device). As explained above, this can be done by any discovery mechanism (e.g. known announcement services). This detection can be activated when any application is launched on the first electronic device, or periodically.

The first electronic device may notify its user (e.g., through a specialized process or compatible application) of the presence of the second electronic device. And, once so notified, the user can decide whether he wants to use said second electronic device (i.e. whether he/she wants to use the input/output capabilities of said second electronic device) or not. The user can also configure the system to establish that association automatically without being notified.

Normally, each electronic device detects the presence of the others, because they are physically close. In one embodiment, two electronic devices coexist within the same communication network (e.g., within the same wireless local area network). In an alternative embodiment, they may belong to different communication networks that are interconnected by means of a tunneling protocol.

As an alternative, instead of using a discovery mechanism to detect and obtain the identity of the first electronic device, the user can request the first (or second) electronic device to provide its identification and any information about connection setup (for example, via a visual code) to the second (or first) electronic device (for example, by scanning the visual code with the second (or first) electronic device).

In one embodiment, a secure connection (also called secure communication) may be established between the first and second electronic devices.

In one embodiment, the second electronic device may present to the user a list of applications available on the first electronic device (previously sent by the first electronic device to the second electronic device through the established secure connection or through another connection). The user can then select on the second electronic device (for example, from a menu displayed to the user) the applications that he/she has available to launch. Then, the second electronic device can notify (via the established connection) the first electronic device of the selected applications and the first electronic device can launch said applications. In an alternative embodiment, the user can select several applications directly on the first electronic device and it can launch them.

The outputs (for example, graphical outputs) of the applications running on the first electronic device can be provided through the established connection to the second electronic device, so that the second electronic device can display them to the user (via a user interface of the second electronic device). In this case, it is assumed that the second electronic device has been previously authorized to access the applications of at least one first electronic device. The applications themselves (directly) or a process that is independent from the applications on the first electronic device can capture the outputs of the applications running on the first electronic device and send them to the second electronic device.

If the second electronic device simultaneously receives the output of several applications to be displayed to the user, it may display the output of each application in a different window of its operating system's windows environment. When the second electronic device also runs local applications, the second electronic device may display, in different windows of its operating system's windows screen, the (graphical) output of its local applications and the output of the applications running on the first electronic device.

In one embodiment, the first electronic device can encode the different outputs, corresponding to various applications, which it wants to display on the screen of the second electronic device, with as many message transmissions as outputs, to deliver them to as many avatars in the second electronic device.

The inputs that the second electronic device receives from the user (by means of a user interface of the second electronic device) can be provided through the established connection to the applications that are running on the first electronic device. Said applications can be prepared to accept inputs directly from the avatars of the second electronic device, or a process of the first electronic device that is independent from the applications can receive said inputs from the second electronic device and pass them to the applications.

In one embodiment, there may be more than one first electronic device (i.e. more than one mobile electronic device) and a second electronic device. In other words, there will be two or more first electronic devices (with the same or different users) that will simultaneously rely on the second electronic device to exchange with the user inputs and outputs of the applications that run simultaneously on said mobile devices. The two (or more) first electronic devices will: detect the second electronic device (or alternatively the second one will detect the first ones), launch one or several applications each, establish (secure) connections with the second electronic device, simultaneously send the outputs of their applications to the second electronic device to display them to the user, and they will receive user input from the second electronic device.

In one embodiment there may be more than one second electronic device and one first electronic device. That is, there will be a first electronic device that will simultaneously exchange with two or more second electronic devices the inputs and outputs of several applications that said first electronic device will execute concurrently. The first electronic device (mobile electronic device) will detect the second electronic devices (or, alternatively, the second electronic devices will detect the first), launch several applications, establish (secure) connections with the second electronic devices, simultaneously send the outputs of the concurrent applications to the second electronic devices to display them to the user(s), and receive the user(s)' inputs from the second electronic devices.

The description and drawings merely illustrate the principles of the invention. Although the present invention has been described with reference to specific embodiments, it should be understood by those skilled in the art that those and other various changes, omissions and additions in form and details thereof may be made without departing from the scope of the present invention as defined by the following claims.

Furthermore, all examples mentioned herein are primarily expressly intended for educational purposes only to assist the reader in understanding the principles of the invention and the concepts advanced by the inventor(s) to foster the art, and are to be interpreted without limitation to the examples and conditions specifically mentioned. Besides, all statements herein that mention principles, aspects, and embodiments of the invention, as well as specific examples thereof, are intended to cover their equivalents.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

Therefore, having thus described the invention, at least the following is claimed:

1. A method of improving a user experience of a user of at least one first electronic device with a first set of device capabilities, where the first electronic device is a mobile electronic device, the method comprising:
at least one second electronic device with a second set of device capabilities, located in at least one of a same communications network and another communications network interconnected with the communications network of the first electronic device, obtaining identity information of the first electronic device;
establishing a connection between the first electronic device and the second electronic device;
an input/output sharing service, which is independent from the multiple applications that are running in the first electronic device, simultaneously capturing a plurality of outputs of the multiple applications, previously selected by the user, by;
encoding at least one message carrying at least one of the plurality of outputs of the multiple applications, previously selected by the user, which are running in the first electronic device,
the first electronic device simultaneously sending to the second electronic device at least one message carrying at least one of the plurality of outputs of the multiple applications, previously selected by the user, which are being executed concurrently in the first electronic device;
receiving in the second electronic device said plurality of outputs for as many instances of an avatar as the multiple applications, previously selected by the user, which are running in the first electronic device;
an input/output sharing service of the second electronic device capturing a user's input, introduced through at least one of the instances of the avatar that are running in the second electronic device;
encoding said user's input as at least one message; and
the input/output sharing service of the second electronic device sending at least one message corresponding to the user's input to the multiple applications that are running concurrently in the first electronic device.

2. The method according to claim 1, wherein obtaining identity information of the first electronic device includes at least one of:
the user commanding the second electronic device to display a visual code that provides the identity of the second electronic device and the user commanding the first electronic device to read the information provided by the visual code; and
the user commanding the first electronic device to display a visual code that provides the identity of the first electronic device and the user commanding the second electronic device to read the information provided by the visual code.

3. The method according to claim 1, comprising:
the second electronic device detecting the presence of the first electronic device upon receiving announcement signals sent by the first electronic device; and
the first electronic device detecting the presence of the second electronic device upon receiving announcement signals sent by the second electronic device.

4. The method according to claim 1, wherein after establishing the connection between the first electronic device and the second electronic device, and before simultaneous capture of the plurality of outputs of multiple applications, the method comprises the following steps:
the first electronic device sending to the second electronic device a list of applications available on the first electronic device through the established connection;
the second electronic device presenting to the user the list of available applications;
the user selecting at the second electronic device one or several applications;
the second electronic device sending a message to the first electronic device informing of the selected applications; and
concurrent launching by the first electronic device of one or more applications identified in the message that have not been launched yet in the first electronic device.

5. The method according to claim 1, wherein after obtaining identity information of the first electronic device, the method further comprising:
the first electronic device asking the user, through a user interface of the first electronic device, if the user accepts establishing application associations with the second electronic device;
the second electronic device asking the user, through a user interface of the second electronic device, if the user agrees to establish application associations with the first electronic device; and
where, if the user does not agree, ending the procedure.

6. The method according to claim 1, wherein the connection between the first electronic device and the second electronic device is a secure connection, wherein certificates of the first and second electronic devices are used to establish the secure connection, and wherein establishing a connection between the first electronic device and the second electronic device includes: checking if a previous connection between the electronic devices has been previously completed, and in that case, each electronic device obtaining the certificate of the other electronic device by taking the certificate from a database.

7. The method according to claim 6, where to exchange the certificates, the first electronic device shows a QR code that includes its security certificate and the second electronic device scans said QR code and extracts the certificate.

8. The method according to claim 1, where the first electronic device is a mobile phone and the second electronic device comprises at least one selected from a group consisting of a laptop, a portable computer, a tablet, a desktop PC and another mobile phone.

9. The method according to claim 1, wherein before simultaneous capture of the plurality of outputs of multiple applications in the first electronic device, the second electronic device has been authorized to access the multiple applications of the first electronic device.

10. The method according to claim 1,
wherein the second electronic device displays the output of each of the multiple applications in a different window of a windows screen using an operating system of the second electronic device, and
wherein in response to the second electronic device also executing at least one of the multiple applications locally, the second electronic device shows in different windows of a second windows screen using an operating system, the outputs of at least one of the local multiple applications and the outputs corresponding to the applications of the first electronic device.

11. The method according to claim 1, where, in addition to the first electronic device, there is at least one other mobile electronic device that sends outputs to the second electronic device and receives inputs from the user at the second electronic device, for the applications running concurrently on said other mobile electronic device.

12. The method according to claim 1, wherein the first electronic device and at least one other electronic device different from the second electronic device carry out the steps of the method to interconnect inputs and outputs of the multiple applications that are executed concurrently in the first electronic device with the at least one other electronic device different from the second electronic device.

13. The method according to claim 1, wherein the first electronic device and the second electronic device are in at least one of a same wireless local area network and a different wireless local area network interconnected by a tunneling protocol.

14. A system for enhancing a user experience of a user of at least one first electronic device with a first set of device capabilities, wherein the first electronic device is a mobile electronic device, the system comprising:
at least one second electronic device having a second set of device capabilities, the second electronic device comprising:
means for obtaining an identity of the first electronic device located in at least one of a same communications network of the second electronic device and a different communications network that is interconnected with the communications network of the second electronic device;
means for establishing a connection with the first electronic device after the second electronic device has obtained the identity of the first electronic device;
a module that receives in the second electronic device message transmissions from the first electronic device encoding outputs of applications, previously selected by the user, which are executed in the first electronic device, reconstructs said outputs to present them to the user, and encodes user inputs to transmit the user inputs to the applications running on the first electronic device;
a display that presents a plurality of instances of avatars corresponding to the applications, previously selected by the user, which are executed concurrently in the first electronic device, to present the outputs to the user and capture the user inputs;
a first user interface for providing the user with the outputs of the multiple avatars running concurrently on the second electronic device;
a second user interface to obtain the user inputs that the user introduces through the multiple avatars that are executed concurrently in the second electronic device;
a transmitter for transmitting to the first electronic device the message transmissions corresponding to the inputs of the multiple avatars that are executed concurrently in the second electronic device; and
a receiver to receive from the first electronic device the message transmissions corresponding to the outputs of the applications, previously selected by the user, which are executed concurrently in the first electronic device;
the first electronic device comprising:
means for establishing a connection with the second electronic device;
a module that intercepts in the first electronic device the outputs of multiple applications, previously selected by the user, which are executed concurrently in the first electronic device;
a transmitter for simultaneously transmitting to the second electronic device the message transmissions corresponding to the outputs of applications, previously selected by the user, which are executed concurrently in the first electronic device; and
a receiver for receiving from the second electronic device the message transmissions corresponding to the inputs for the applications, previously selected by the user, which are executed concurrently in the first electronic device.
